(19) United States
(12) Patent Application Publication
(10) Pub. No.: US 2003/0201759 A1
(43) Pub. Date: Oct. 30, 2003

(54) Full duplexing for power line data communications

(75) Inventor: Yehuda Cern, Brookline, MA (US)

Correspondence Address: Charles N.J. Ruggiero, Esq., Ohlandt, Greeley, Ruggiero & Perle, L.L.P., One Landmark Square, 10th Floor, Stamford, CT, 06901-2682, US

(73) Assignee: Ambient Corporation

(21) Appl. No.: 10/425,703

(22) Filed: Apr. 29, 2003

Related U.S. Application Data
(60) Provisional application No. 60/376,109, filed on Apr. 29, 2002.

(51) Int. Cl. G05F 1/12

(52) U.S. Cl. 323/247

(57) ABSTRACT

There is provided a coupling circuit for a full duplex modem having a transmitter and a receiver. The coupling circuit includes (a) a first transformer having a primary winding and a secondary winding, where the primary winding is coupled to the transmitter, (b) a second transformer having a primary winding and a secondary winding, where the primary winding of the second transformer is coupled to a communications line, and (c) a resistance between a terminal of the primary winding of the first transformer and a terminal of the primary winding of the second transformer. The secondary windings of the first and second transformers are connected in series, with opposing phase, and coupled to the receiver to minimize a level of a signal from the transmitter from reaching the receiver.

### CROSS REFERENCE TO RELATED APPLICATIONS

The present application is claiming priority of U.S. Provisional Patent Application Serial No. 60/376,109, filed on Apr. 29, 2002.

### BACKGROUND OF THE INVENTION

1. Field of the Invention

The present invention generally relates to coupling communication signals to electrical power distribution systems, and more specifically to full duplex communications over electric power lines and other electrical lines having widely varying drive point impedance.

2. Description of the Related Art

Data communications can be accomplished between modems connected via electric power lines, but widely varying drive point impedance of such power lines should be considered. Typically, a power line modem may include a high frequency transmitter and a high frequency receiver that need to operate simultaneously over different frequency bands. In the case of spread spectrum modems, the transmitting and receiving frequency bands are relatively broad. Unfortunately, high frequency power amplifiers like those typically used in the output stage of the transmitter are not perfectly linear. Their non-linearity produces intermodulation (IM) products over a broad frequency range outside the transmission band. Some of these IM products will fall within the receiver's frequency band and interfere with incoming signals from distant second modems.

Ideally, the transmitter power should reach only the power line connected to the modem output terminals, with none of the transmitter output reaching receiver input terminals. However, for power line modems, a single pair of powerline terminals serves for both the transmitter output and the receiver input. During full duplex communications, when both transmitter and receiver are simultaneously active, a three-port network called a “hybrid coupler” connects both the transmitter and the receiver to the line. Ideally, there should be a lossless connection for incoming signals from the powerline port to the receiver, a lossless connection between transmitter and the powerline terminals, and complete isolation between transmitter and receiver.

Such networks have been described for analog telephones, which similarly need to transmit and receive over a single pair of wires. Hybrid couplers for full duplexing can provide high transmitter-receiver isolation, but the degree of isolation depends on the accuracy of the impedance match between the modem impedance and the load impedance. In the case of analog telephone networks such accurate impedance matching is not a problem, but for power line networks the load impedance seen at the powerline terminals varies widely over the frequency bands of interest, and the hybrid's isolation between transmitter and receiver may be severely degraded.

The signal-to-noise ratio at the receiver may be degraded significantly when a substantial amount of spurious transmitter output falls within the receiver's input frequency band and power line impedance mismatch causes some of that spurious energy to reach the receiver's input terminals. That can cause data errors or force a reduction of the data rate to maintain acceptable error rates.

FIG. 1 shows a generic hybrid coupler 110 connected to the output terminals 103 of a transmitter output stage 100, which is driven by a modem low power transmitter 106. Hybrid coupler 110 is also connected to a communications line that acts as a load on the modem and has an impedance represented by lump impedance Z_{L} 115. Hybrid coupler 110 is further connected to receiver input terminals 120 of a receiver 125. For full duplex modems, transmitter output stage 100 is typically push-pull, to cancel out much of the even harmonic energy across its differential output terminals 103. Ideally, when the nominal design impedance of hybrid coupler 110 equals impedance Z_{L} 115, there is no feedthrough between the transmitter output at terminals 103 and the receiver input terminals 120. But, when the nominal design impedance of hybrid coupler 110 is substantially different from impedance Z_{L} 115, for instance, as in the real world case where power line impedance is a complex variable, the attenuation between output terminals 103 and input terminals 120 can fall to very low levels, and a significant amount of undesirable IM products can reach receiver 125.

For example, for line impedance of Z_{L} 115 of 12.5 ohms resistive, the level of transmitted signal leaking into receiver 125 will be only 6 dB weaker than the full transmitter output. In the more typical case of Z_{L} 115 being a complex impedance and not purely resistive, the leakage is even worse.

### SUMMARY OF THE INVENTION

Embodiments of the present invention include a hybrid coupling circuit and corresponding method for a full duplex modem. A first transformer has primary and secondary windings with a secondary to primary turns ratio of 1:1. The first transformer primary winding is connected across outputs of a modem transmitter. A pair of transmitter output resistors are connected in series between each transmitter output terminal to a corresponding communications line terminal. A second transformer has primary and secondary windings with a secondary to primary turns ratio corresponding to a ratio of voltages between the transmitter output terminals and between the voltage across the load-side terminals of the output resistors under matched load conditions. The second transformer primary winding is connected in parallel across the communications line. The secondaries of the transformers are connected together in series with opposing phase so as to: (i) cancel a signal transmitted from the transmitter, and (ii) provide a path for a signal from the communications line to the receiver.

In a further embodiment, an attenuation pad may be connected between the line impedance and the second transformer primary winding so as to improve feedthrough cancellation performance under conditions of line impedance mismatch.

### BRIEF DESCRIPTION OF THE DRAWINGS

The present invention will be more readily understood by reference to the following detailed description taken with the accompanying drawings, in which:

FIG. 1 shows a generic hybrid coupler for full duplexing according to the prior art.

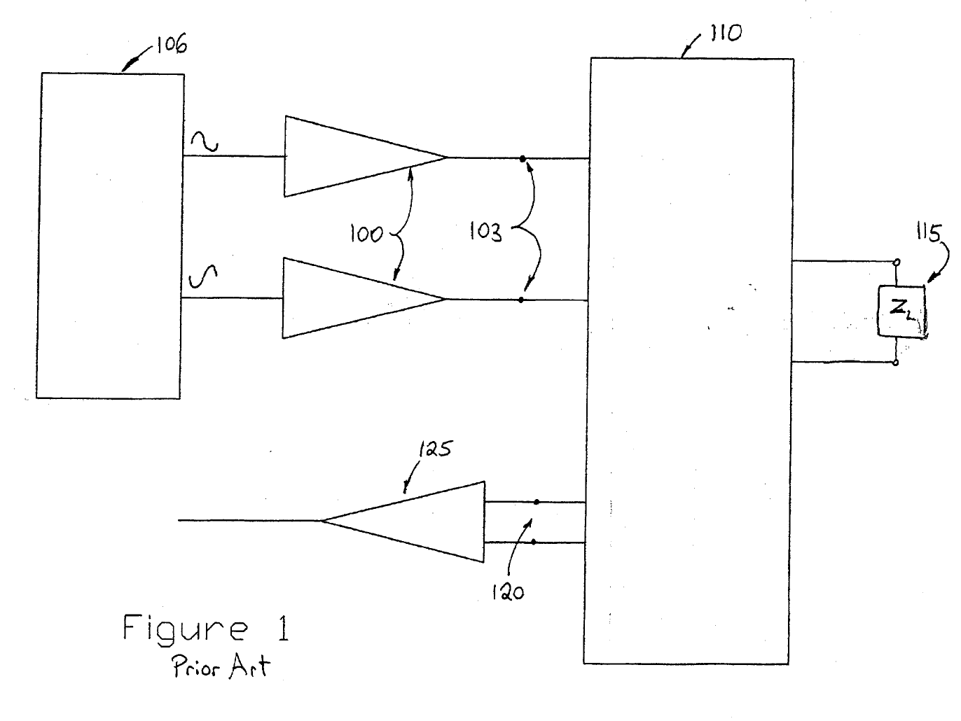

FIG. 2 shows a hybrid coupler for full duplexing according to one embodiment of the present invention.

FIG. 3 shows another embodiment of a hybrid coupler for full duplexing.

### DESCRIPTION OF THE INVENTION

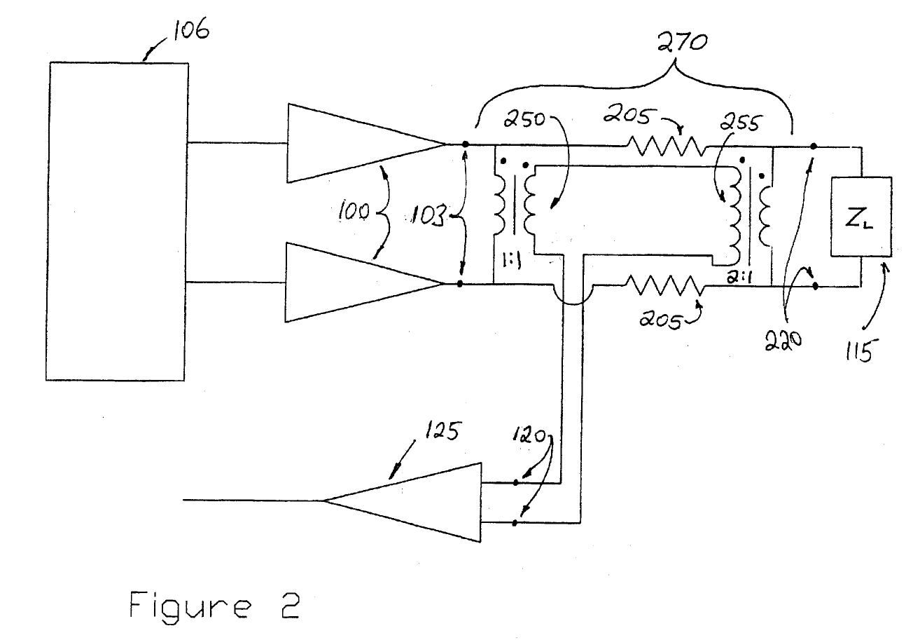

FIG. 2 shows a hybrid coupler 270 for full duplexing according to one embodiment of the present invention. Typical solid state high frequency line drivers 100, such as may be used as modem transmitter output stages, often have near-zero output impedance. Impedance matching and current limiting is achieved through external resistors 205. A particular powerline nominal impedance, e.g. 50 ohms, is used for purposes of illustrating a design. For power line loads, represented here by Z_{L} 115 that display the nominal 50 ohms, the transmitter voltage between terminal pair 220 will be one half that at driver terminal pair 103.

If the voltage across terminals 220 could be doubled and subtracted from the voltage across terminals 103, the resulting voltage would perfectly cancel the transmitter voltage. FIG. 2 shows this accomplished by the addition of transformers 250 and 255, with the turns ratio of transformer 255 being double that of transformer 250, and where secondaries of transformers 250 and 255 are connected in series to provide a difference output that is connected to an input of a receiver 125 via receiver terminals 120.

In contrast to the cancellation of the transmitter signal at receiver terminals 120, the circuit sends a received line signal to receiver 125 via transformer 255. Transformer 250 provides no voltage, as its primary is short circuited by the very low output impedance of the transmitter output stage, line drivers 100, and this short circuit is reflected as a near zero impedance across the secondary of transformer 250. A practitioner knowledgeable in the art could generalize the transformer ratios of transformers 250 and 255 to compensate for the expected ratio of voltages across terminal pairs 103 and 220, and also change their absolute ratios to facilitate optimal impedance matching to receiver 125. Thus, 1:1 and 2:1 could also be 3:1 and 6:1, achieving the same cancellation. The voltage across the right hand winding of transformer 255 is half the voltage across line drivers 100 for matched load impedance. So if transformer 255 boosts this half voltage by a factor of 6, while transformer 250 boosts the full voltage by a factor of 3, the subtracted voltage arriving at receiver 125 is zero.

For matched impedance conditions, resistors 205, whose sum is selected to equal the nominal modem impedance, will load the incoming signal by 50%, or 6 dB. The transformer action of transformer 255 will restore the amplitude of the original received signal, albeit at an impedance level twice as high as the modem's nominal impedance. Nevertheless, the secondaries of the transformers 250 and 255 are connected together in series with opposing phase so as to: (i) cancel a signal transmitted from transmitter line drivers 100, and (ii) provide a path for a signal from the communications line (i.e., terminals 220) to receiver 125.

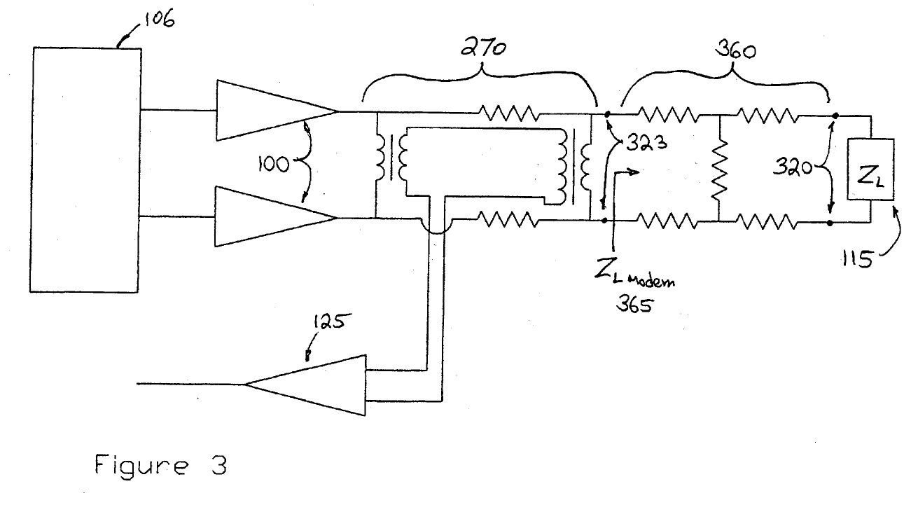

FIG. 3 is a schematic of a circuit that employs a method of stabilizing the impedance Z_{L Modem} 365 seen by the modem hybrid 270, to ameliorate effects of widely varying powerline impedance Z_{L} 115. The circuit of FIG. 3 utilizes the impedance-stabilization characteristic of a resistive attenuator pad 360, designed as an H-network attenuator with characteristic impedance equal to the modem's nominal impedance. If resistive attenuator pad 360 is installed between modem line terminals 323 and power line terminals 320, then variations in the termination impedance Z_{L Modem} 365 seen by hybrid 270 are greatly reduced, and the ability of hybrid 270 to minimize leakage between transmitter line drivers 100 and receiver 125 is greatly enhanced.

A resistive attenuator, such as resistive attenuator pad 360, has terminal impedances such as Z_{L Modem} 365, that depend upon both the resistor values used in resistive attenuator pad 360 and upon load impedance Z_{L} 115. Using extremes for illustration, a shorted load impedance Z_{L} 115 would reduce Z_{L Modem} 365 but not reduce it to zero, while a disconnected load impedance Z_{L} 115 would increase Z_{L Modem} 365 but not make it infinite. Similarly, for less drastic changes in Z_{L} 115, Z_{L Modem} 365 would vary more mildly than Z_{L} 115. This has the effect of stabilizing the impedance Z_{L Modem} 365 as seen from terminals 323 against variations in power line load impedance Z_{L} 115. This benefit is obtained at the expense of signal level, and the reduction of signal level is termed loss.

The stabilization effect of resistive attenuator pad 360 increases with increasing pad attenuation, but at the cost of reducing both the transmitter power level reaching the power line, represented by load Z_{L} 115 and the received signal at the receiver 125. The transmitted modem output power level into load Z_{L} 115 can be stored to its previous level by increasing the output stage power from line drivers 100 to compensate for the attenuator loss, being careful not to increase the level of IM distortion.

The effect on the receiver ratio of signal-to-IM leakage noise is more complex. On one hand, the signal level is attenuated by resistive attenuator pad 360. However, for the frequently encountered case of line impedance much different from the nominal modem impedance, the effect of resistive attenuator pad 360 on improving the impedance match seen by hybrid 270 may result in a reduction of transmitter IM product feedthrough, providing an overall improvement in receiver signal to IM noise ratio.

A series of simulations were performed on the circuits shown in FIGS. 2 and 3, and the results tabulated in Tables 1-3 below. For example, an attenuation of 10 dB by resistive attenuator pad 360 provides the following improvement in transmitter to receiver signal leakage, for powerline impedances different from nominal, as shown in Tables 1-3.

TABLE 1
Transmitter to Receiver Feedthrough W/21v Transmitter Output

| | without Pad | | | |
|---|---|---|---|---|
| Load | Transformer | | with 10 dB Pad | |
| Resistance | Hybrid | | Transformer | |
| (ohms) | Voltage | dB Down | Hybrid Voltage | dB Down |
| 12.5 | 10.7 | −5.9 | 1.05 | −26.0 |
| 25 | 5.2 | −12.1 | 0.53 | −32.0 |
| 40 | 1.6 | −22.4 | 0.10 | −46.4 |
| 60 | 1.3 | −24.5 | 0.28 | −37.5 |
| 100 | 4.3 | −13.8 | 0.74 | −29.1 |
| 200 | 7.1 | −9.4 | 1.24 | −24.6 |
| 400 | 8.7 | −7.7 | 1.58 | −22.5 |
| | Average: | −13.7 | Average: | −31.1 |

TABLE 2
Receiver Performance

| | without Pad | | | | | |
|---|---|---|---|---|---|---|
| Load | Resist. | | with 10 dB Pad | | | |
| Resist. | Hybrid | Rcvr. | | Xfrmr | | |
| (ohms) | Input | Loss | | Hybrid | Rcvr. Loss | |
| 12.5 | 0.046 | −26.7 | 0.950 | 0.23 | −12.8 | −12.32 |
| 25 | 0.038 | −28.4 | 0.906 | 0.19 | −14.4 | −13.56 |
| 40 | 0.032 | −29.9 | 0.857 | 0.158 | −16.0 | −14.69 |
| 50 | 0.028 | −31.1 | 0.828 | 0.141 | −17.0 | −15.37 |
| 60 | 0.0255 | −31.9 | 0.800 | 0.130 | −17.7 | −15.78 |
| 100 | 0.0185 | −34.7 | 0.706 | 0.095 | −20.4 | −17.42 |
| 200 | 0.0115 | −38.8 | 0.545 | 0.058 | −24.7 | −19.47 |
| 400 | 0.0065 | −43.7 | 0.375 | 0.033 | −29.6 | −21.11 |
| | average | −33.1 | | average | −19.1 | |

TABLE 3
Transmitted Output Power Reaching Load

| | without Pad | | | |
|---|---|---|---|---|
| | | Power, | with 10 dB Pad | |
| | | relative to | | Power, relative |
| Load | | 10 Vrms in | | to 10 Vrms in |
| Resistance | Output, Volts | 50 ohms, | Output | 50 ohms, |
| (ohms) | p-p | dB | Volts p-p | dB |
| 12.5 | 9.0 | 5.1 | 2.8 | −5.0 |
| 25 | 14.5 | 6.2 | 4.4 | −4.1 |
| 40 | 19.0 | 6.5 | 6.0 | −3.5 |
| 50 | 20.5 | 6.2 | 6.7 | −3.5 |
| 60 | 22.6 | 6.3 | 7.3 | −3.5 |
| 100 | 27.3 | 5.7 | 8.9 | −4.0 |
| 200 | 31.9 | 4.1 | 10.7 | −5.4 |
| 400 | 34.7 | 1.8 | 11.8 | −7.6 |
| | Average: | 5.2 | Average: | −4.6 |

For example, in the first line of Table 1, it can be seen that with a power line load resistance of 12.5 ohms, or one fourth the nominal modem impedance, the hybrid circuit 270 of FIG. 2 would only attenuate the transmitter signal by 5.9 dB at the receiver's input terminals, while the addition of a 10 dB resistive attenuator pad 360 as shown in FIG. 3 improves that figure to 26 dB, a 20.1 dB improvement. Table 2 indicates that average received power is improved by −33.1−(−19.1) or 14 dB. The ratio of received power loss in Table 2 to Transmitter to Receiver Feedthrough shown in Table 1 has improved from −33.1−(−13.7)=19.6 dB to −19.1−(−31.1)=12 dB, or 19.6−12=7.6 dB better. Table 3 shows that average transmitted power is down by 5.2−(−4.6)=9.8 dB, but this can be compensated for by increasing the output of line drivers 200 to 1 W.

Typical highly linear transmitter line drivers 100 have IM products down 45 dB from the carrier. A further 26 dB isolation places the IM products at the receiver terminals down 71 dB from the transmitter, the order of magnitude of a signal received from a modem elsewhere on the line which has suffered strong attenuation. Where the IM leakage attenuation is only the 5.9 dB noted (see first line of Table 1), then the IM products would be −5.9−45+71=20.1 dB stronger than the received signal.

Although various exemplary embodiments of the invention have been disclosed, it should be apparent to those skilled in the art that various changes and modifications can be made which will achieve some of the advantages of the invention without departing from the true scope of the invention

What is claimed is:

1. A coupling circuit for a full duplex modem having a transmitter and a receiver, said circuit comprising:
a first transformer having a primary winding and a secondary winding, wherein said primary winding is coupled to said transmitter;
a second transformer having a primary winding and a secondary winding, wherein said primary winding of said second transformer is coupled to a communications line; and
a resistance between a terminal of said primary winding of said first transformer and a terminal of said primary winding of said second transformer,
wherein said secondary windings of said first and second transformers are connected in series, with opposing phase, and coupled to said receiver to minimize a level of a signal from said transmitter from reaching said receiver.

2. The coupling circuit of claim 1, wherein said coupling circuit:
(i) couples a first signal from said transmitter to said communications line; and
(ii) couples a second signal from said communications line to said receiver.

3. The coupling circuit of claim 1, wherein said first transformer has a secondary to primary turns ratio of 1:1 and said second transformer as a secondary to primary turns ratio of 2:1.

4. The coupling circuit of claim 1, wherein said second transformer has a turns ratio that is twice that of said first transformer.

5. The coupling circuit of claim 1, further comprising an attenuation pad connected between said primary winding of said second transformer and said communications line.

6. The coupling circuit of claim 5, wherein said attenuation pad improves feedthrough cancellation between said transmitter and said receiver under conditions of mismatch between said modem impedance and impedance of said communications line.

7. A coupling circuit for a full duplex modem having a transmitter and a receiver, said circuit comprising:
a first transformer having a primary winding connected across a first output terminal and a second output terminal of said transmitter, wherein said first transformer has a secondary winding and a secondary to primary turns ratio of 1:1;
a pair of resistors, wherein a first resistor of said pair is connected in series with said first output terminal and a first conductor of a communications line, and a second resistor of said pair is connected in series with said second output terminal and a second conductor of said communications line, wherein a sum of values of said resistors establishes impedance of said modem; and
a second transformer having a primary winding connected in parallel across said first and second conductors of said communications line, wherein said second transformer has a secondary winding and a secondary to primary turns ratio corresponding to a ratio of voltage between said output terminals of said transmitter and said conductors of said communications line, under matched load conditions,
wherein said secondary windings of said first and second transformers are connected in series, with opposing phase, to:
(i) cancel a signal transmitted from said transmitter, and
(ii) provide a path for a signal from said communications line to said receiver.

8. The coupling circuit of claim 7, further comprising an attenuation pad connected between said second transformer primary winding and said communications line.

9. The coupling circuit of claim 8, wherein said attenuation pad improves feedthrough cancellation between said transmitter and said receiver under conditions of mismatch between said modem impedance and impedance of said communications line.

10. A method of coupling a full duplex modem having a transmitter and a receiver, said method comprising:
connecting a primary winding of a first transformer to a transmitter;
connecting a primary winding of a second transformer to a communications line;
connecting a resistance between a terminal of said primary winding of said first transformer and a terminal of said primary winding of said second transformer;
connecting a secondary winding of said first transformer in series with a secondary winding of said second transformer, with opposing phase; and
coupling said secondary windings of said first and second transformers to said receiver to minimize a level of a signal from said transmitter from reaching said receiver.

11. The method of claim 10, wherein said coupling circuit:
(i) couples a first signal from said transmitter to said communications line; and
(ii) couples a second signal from said communications line to said receiver.

12. The method of claim 10, wherein said first transformer has a secondary to primary turns ratio of 1:1 and said second transformer as a secondary to primary turns ratio of 2:1.

13. The method of claim 10, wherein said second transformer has a turns ratio that is twice that of said first transformer.

14. The method of claim 10, further comprising connecting an attenuation pad between said primary winding of said second transformer and said communications line.

15. The method of claim 14, wherein said attenuation pad improves feedthrough cancellation between said transmitter and said receiver under conditions of mismatch between said modem impedance and impedance of said communications line.

16. A method of coupling a full duplex modem having a transmitter and a receiver, said method comprising:
connecting a primary winding of a first transformer across a first output terminal and a second output terminal of said transmitter, wherein said first transformer has a secondary winding and a secondary to primary turns ratio of 1:1;
connecting a pair of resistors, wherein a first resistor of said pair is connected in series with said first output terminal and a first conductor of a communications line, and a second resistor of said pair is connected in series with said second output terminal and a second conductor of said communications line;
connecting a primary winding of a second transformer in parallel across said first and second conductors of said communications line, wherein said second transformer has a secondary winding and a secondary to primary turns ratio corresponding to a ratio of voltage between said output terminals of said transmitter and said conductors of said communications line, under matched load conditions; and
connecting the secondary winding of the first and second transformers in series, with opposing phase, to:
(i) cancel a signal transmitted from said transmitter, and
(ii) provide a path for a signal from said communications line to said receiver.

17. The method of claim 16, further comprising connecting an attenuation pad between said second transformer primary winding and said communications line.

18. The method of claim 17, wherein said attenuation pad improves feedthrough cancellation between said transmitter and said receiver under conditions of mismatch between said modem impedance and impedance of said communications line.
